(19) United States
(12) Patent Application Publication
(10) Pub. No.: US 2026/0281848 A1
(43) Pub. Date: Sep. 17, 2026

(54) CONDITION FOR KNOWN CELL AND TRANSMISSION CONFIGURATION INDICATION STATE

(71) Applicant: Nokia Technologies Oy, Espoo (FI)

(72) Inventors: Tachporn SANGUANPUAK, Oulu (FI); Keeth Saliya Jayasinghe LADDU, Espoo (FI); Sanjay GOYAL, Murray Hill, NJ (US); Timo KOSKELA, Oulu (FI)

(21) Appl. No.: 19/079,979

(22) Filed: Mar. 14, 2025

(51) Int. Cl. H04W 36/08; H04W 36/00

(52) U.S. Cl. CPC H04W 36/08; H04W 36/0058

(57) ABSTRACT

Devices, methods, apparatuses and computer readable storage medium for determination of a known cell and a transmission configuration indication (TCI) state. are provided. In a method, a first apparatus receives, from a second apparatus, a cell switch command indicating the first apparatus to switch to a candidate cell. The first apparatus determines that the candidate cell is known, according to a prediction associated with the candidate cell. The first apparatus switches from a source cell to the candidate cell based on the candidate cell being known.

### FIELD

Various example embodiments of the present disclosure generally relate to the field of telecommunication and in particular, to devices, methods, apparatuses and computer readable storage medium for determination of a known cell and a transmission configuration indication (TCI) state.

### BACKGROUND

Beam prediction refers to the process of forecasting the optimal beam directions for transmission and reception in wireless communication systems. This process leverages artificial intelligence (AI)/machine leaning (ML) models to enhance the efficiency and reliability of beam management by anticipating the best beam pairs before they are needed, thereby reducing the overhead and latency associated with cell switching.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, a cell switch command indicating the first apparatus to switch to a candidate cell; determine that the candidate cell is known, according to a prediction associated with the candidate cell; and switch from a source cell to the candidate cell based on the candidate cell being known.

In a second aspect of the present disclosure, there is provided a method at a first apparatus. The method comprises: receiving, from a second apparatus, a cell switch command indicating the first apparatus to switch to a candidate cell; determining that the candidate cell is known, according to a prediction associated with the candidate cell; and switching from a source cell to the candidate cell based on the candidate cell being known.

In a third aspect of the present disclosure, there is provided a first apparatus. The first apparatus comprises means for receiving, from a second apparatus, a cell switch command indicating the first apparatus to switch to a candidate cell; means for determining that the candidate cell is known, according to a prediction associated with the candidate cell; and means for switching from a source cell to the candidate cell based on the candidate cell being known.

In a fourth aspect of the present disclosure, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a schematic diagram of an example model inference process for beam management;

FIG. 3 illustrates a signaling flow of an example process of determination of a known cell in accordance with some example embodiments of the present disclosure;

FIG. 4 illustrates an example signaling flowchart of an example process of determination of a known cell in accordance with some example embodiments of the present disclosure;

FIG. 5 illustrates an example signaling flowchart of another example process of determination of a known cell in accordance with some example embodiments of the present disclosure;

FIG. 6 illustrates a signaling flow of an example process of determination of a known TCI state in accordance with some example embodiments of the present disclosure;

FIG. 7 illustrates an example signaling flowchart of an example process of determination of a known TCI state in accordance with some example embodiments of the present disclosure;

FIG. 8 illustrates a signaling flow of an example process of determination of a cell and a TCI state in accordance with some example embodiments of the present disclosure;

FIG. 9 shows a flowchart of an example method implemented at a first apparatus in accordance with some example embodiments of the present disclosure;

FIG. 10 shows a flowchart of an example method implemented at a second apparatus in accordance with some example embodiments of the present disclosure;

FIG. 11 shows a flowchart of an example method 1100 implemented at a first apparatus in accordance with some example embodiments of the present disclosure;

FIG. 12 shows a flowchart of an example method 1200 implemented at a first apparatus in accordance with some example embodiments of the present disclosure;

FIG. 13 shows a flowchart of an example method implemented at a first apparatus in accordance with some example embodiments of the present disclosure;

FIG. 14 illustrates a simplified block diagram of a device that is suitable for implementing example embodiments of the present disclosure; and

FIG. 15 illustrates a block diagram of an example computer readable medium in accordance with some example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second,” , etc. in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a user device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5G-advanced, the sixth generation (6G) communication protocols, wireless local network communication protocols such as Institute for Electrical and Electronics Engineers (IEEE) 802.11 and the like, and/or any other protocols either currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a user device accesses the network and receives services therefrom. The network device may refer to a base station (BS) or an access point (AP), for example, a node B (NodeB or NB), an evolved NodeB (eNodeB or eNB), an NR NB (also referred to as a gNB), a remote radio unit (RRU), a radio head (RH), a remote radio head (RRH), a relay, an integrated access and backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a centralized unit (CU) and a distributed unit (DU) at an IAB donor node. An IAB node comprises a mobile terminal (IAB-MT) part that behaves like a UE toward the parent node, and a DU part of an IAB node behaves like a base station toward the next-hop IAB node.

The term “user device” refers to any end device that may be capable of wireless communication. By way of example rather than limitation, a user device may also be referred to as user equipment (UE), a subscriber station (SS), a portable subscriber station, a mobile station (MS), or an access terminal (AT). The user device may include, but not limited to, a mobile phone, a cellular phone, a smart phone, voice over IP (VoIP) phones, wireless local loop phones, a tablet, a wearable user device, a personal digital assistant (PDA), portable computers, desktop computer, image capture user devices such as digital cameras, gaming user devices, music storage and playback appliances, vehicle-mounted wireless user devices, wireless endpoints, mobile stations, laptop-embedded equipment (LEE), laptop-mounted equipment (LME), universal serial bus (USB) dongles, smart devices, wireless customer-premises equipment (CPE), an internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The user device may also correspond to a mobile termination (MT) part of an IAB node (e.g., a relay node). In the following description, the terms “user device”, “terminal device”, “terminal”, “user equipment” and “UE” may be used interchangeably.

The term “artificial intelligence (AI)/machine learning (ML) model” refers to a data driven algorithm that applies AI/ML techniques to generate a set of outputs based on a set of inputs. The term “AI/ML model delivery” refers to a generic term related to delivery of the AI/ML model from one entity to another entity in any manner. It is noted that the entity could mean a network node/function (e.g., the gNB, a location management function (LMF), etc.), the user device, a proprietary server, etc. The term “AI/ML model inference” refers to a process of using a trained AI/ML model to produce the set of outputs based on the set of inputs.

The term “AI/ML model testing” refers to a subprocess of training, to evaluate the performance of a final AI/ML model using a dataset different from one used for model training and validation. Differently from the AI/ML model validation, the AI/ML model testing does not assume subsequent tuning of the model. The term “AI/ML model training” refers to a process to train the AI/ML Model (by learning input/output relationship) in a data driven manner and obtain the trained AI/ML Model for inference. The term “AI/ML model transfer” refers to a delivery of the AI/ML model over an air interface in a manner that is not transparent to 3GPP signaling, either parameters of a model structure known at a receiving end or a new model with parameters. The delivery may contain a full model or a partial model. The term “AI/ML model validation” refers to a subprocess of training, to evaluate the quality of the AI/ML model using a dataset different from one used for model training, that helps selecting model parameters that generalize beyond the dataset used for the model training.

The term “data collection” refers to a process of collecting data by the network nodes, a management entity, or the user device for the purpose of the AI/ML model training, data analytics and inference. The term “federated learning/federated training” refers to the ML technique that trains the AI/ML model across multiple decentralized edge nodes (e.g., the user devices, the gNBs) each performing local model training using local data samples. The technique requires multiple interactions of the model, but no exchange of the local data samples.

The term “model download” refers to a model transfer from the network device to the user device. The term “model identification” refers to a process/method of identifying the AI/ML model for the common understanding between the network device and the user device. It is noted that the process/method of model identification may or may not be applicable. It is noted that information regarding the AI/ML model may be shared during the model identification. The term “model monitoring” refers to a procedure that monitors an inference performance of the AI/ML model. The term “model update” refers to a process of updating the model parameters and/or model structure of the model. The term “model upload” refers to a model transfer from the user device to the network device.

The term “network-side AI/ML model” refers to an AI/ML model whose inference is performed entirely at the network device. The term “UE-side AI/ML model” refers to an AI/ML model whose inference is performed entirely at the user device. The term “two-sided AI/ML model” refers to a paired AI/ML model(s) over which a joint inference is performed, where the joint inference comprises AI/ML inference whose inference is performed jointly across the user device and the network device, i.e, the first part of the inference is firstly performed by the UE and then the remaining part is performed by the gNB, or vice versa.

The term “offline training” refers to an AI/ML training process where the model is trained based on the collected dataset, and where the trained model is later used or delivered for the inference. It is noted that this definition only serves as a guidance. There may be cases that may not exactly conform to this definition but could still be categorized as the offline training by commonly accepted conventions. The term “online training” refers to the AI/ML training process where the model being used for the inference is (typically continuously) trained in (near) real-time with an arrival of new training samples. It is noted that a notion of (near) real-time vs. non-real-time is context-dependent and is relative to the inference timescale. It is also noted that this definition only serves as a guidance. There may be cases that may not exactly conform to this definition but could still be categorized as the online training by commonly accepted conventions. It is also noted that fine-tuning/re-training may be done via the online or the offline training.

The term “reinforcement learning (RL)” refers to a process of training the AI/ML model from the input (as known as a state) and a feedback signal (also known as reward) resulting from the output (also known as an action) in an environment the model is interacting with. The term “semi-supervised learning” refers to a process of training a model with a mix of labeled data and unlabeled data. The term “supervised learning” refers to a process of training a model from input and its corresponding labels. The term “unsupervised learning” refers to the process of training a model without labelled data.

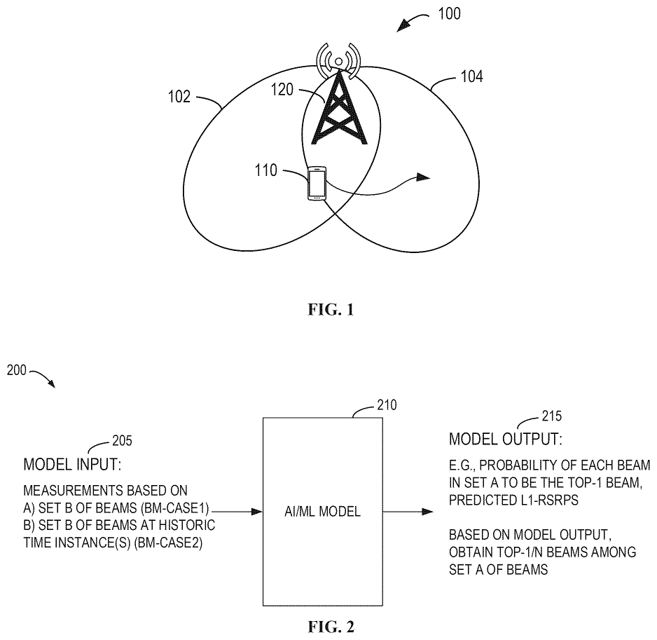

FIG. 1 illustrates an example communication environment 100 in which example embodiments of the present disclosure can be implemented. As shown in FIG. 1, the communication environment 100 may comprise a plurality of communication devices, including a first apparatus 110 and a second apparatus 120. The first apparatus 110 may operate as a terminal device (for example, a UE) and the second apparatus 120 may operate as an access network (e.g., RAN) device (for example, a BS or a gNB).

The first apparatus 110 may communicate with the second apparatus 120 within a source cell 102 which is a serving area provided by the second apparatus 120. The source cell 102 currently serving the first apparatus 110 may be also referred to as a serving cell.

When the first apparatus 110 moves from the source cell 102 to a candidate cell 104, a cell switch from the source cell 102 to the candidate cell 104 may be triggered. For example, in some example embodiments, the first apparatus 110 may measure a signal strength and quality of the source cell 102 and neighboring cells, including a candidate cell 104 provided by the second apparatus 120. Then, the first apparatus 110 may report the measurement results to the second apparatus 120 and the second apparatus 120 may evaluate the measurement results and decide whether a handover is necessary to maintain optimal communication quality. If a handover is required, the second apparatus 120 may indicate the first apparatus 110 to switch from the source cell 102 to the candidate cell 104.

In some example embodiments, both the source cell 102 and the candidate cell 104 may be provided by the second apparatus 120. Alternatively, or in addition, the candidate cell 104 may be provided by another network device (e.g., a gNB).

In some example embodiments, the second apparatus 120 may activate and/or indicate a TCI state based on the measurement results reported by the first apparatus 110 (e.g., based on the downlink reference signal (RS) resources that the first apparatus 110 has actually measured) to avoid long delays in beam switching. Alternatively, or in addition, the second apparatus 120 may activate and/or indicate a TCI state based on a predicted signal quality of the downlink RS resources predicted by the first apparatus 110.

It is to be understood that the number or type of apparatuses or devices and their connections shown in FIG. 1 is given for the purpose of illustration without suggesting any limitations. The communication environment 100 may include any suitable number or type of apparatuses or devices configured to implement example embodiments of the present disclosure. Although not shown, it would be appreciated that one or more additional terminal devices may be located in the cell 102, and/or one or more additional cells may be provided by the second apparatus 120.

In some example embodiments, if the first apparatus 110 is a terminal device or included in a terminal device and the second apparatus 120 is a RAN device or is included in a RAN device, a link from the second apparatus 120 to the first apparatus 110 is referred to as a downlink (DL), and a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device and the second apparatus 120 is an RX device.

For artificial intelligence (AI)/ machine learning (ML)-based beam management (BM), it has been agreed to support BM-Case 1 and BM-Case 2. In BM-Case 1, the first apparatus 110 may perform a spatial-domain downlink beam prediction for Set A of beams based on measurement results of Set B of beams. In some examples, the training and inference of an AI/ML model for BM-Case 1 may be implemented at the first apparatus 110 or the second apparatus 120.

In some examples, Set A and Set B are different, and Set B is not a subset of Set A. Alternatively, Set B is a subset of Set A. Set A may be used for DL beam prediction and Set B may be a set of beams measurements of which are taken as inputs of the AI/ML model.

In some examples, the following alternatives for an input of the AI/ML model may be supported: only a layer 1 (L1)-reference signal receiving power (RSRP) measurement based on Set B, an L1-RSRP measurement based on Set B and assistance information, a channel impulse response (CIR) based on Set B and an L1-RSRP measurement based on Set B and the corresponding DL Tx and/or Rx beam identifier (ID).

In BM-Case 2, the first apparatus 110 may perform a temporal downlink beam prediction for Set A of beams based on the historic measurement results of Set B of beams. In some examples, the training and inference of an AI/ML model for BM-case 2 may be implemented at the first apparatus 110 or the second apparatus 120.

In some examples, Set A and Set B are different, and Set B is not a subset of Set A. Alternatively, Set B is a subset of Set A. Alternatively, Set A and Set B are the same.

In some examples, measurement results of K (where K is a positive integer, and K≥1) latest measurement instances with the following alternatives for the input of the AI/ML model may be supported: only an L1-RSRP measurement based on Set B, an L1-RSRP measurement based on Set B and assistance information and an L1-RSRP measurement based on Set B and the corresponding Tx and/or Rx beam ID.

In some examples, F (where F is a positive integer, and F≥1) predictions for F future time instances may be obtained based on the output of AI/ML model, where a prediction is for a time instance. In some examples, beams in Set A and Set B may be in the same frequency range. For BM-Case l and BM-Case 2, the following alternatives may be studied for the predicted beams: a Tx beam prediction, a Rx beam prediction and a beam pair prediction (a beam pair includes a Tx beam and a corresponding Rx beam).

In some examples, the following alternatives according to an output of the AI/ML model may be supported: Tx and/or Rx Beam ID(s) and/or the predicted L1-RSRP (s) of the N (where N is a positive integer, and N≥1) predicted Tx and/or Rx beams, Tx and/or Rx Beam ID(s) of the N predicted Tx and/or Rx beams and other information, and Tx and/or Rx Beam angle(s) and/or the predicted L1-RSRP(s) of the N predicted Tx and/or Rx beams. The N predicted beams may be the Top-N predicted beams. All of the outputs in the above alternatives may vary based on whether the AI/ML model inference is at the first apparatus 110 or the second apparatus 120. The Top-N beam IDs may be derived via post-processing of the ML-model output.

For BM-case 1 and BM-case 2 with the AI/ML model at the first apparatus 110 the necessity and potential BM-specific conditions/additional conditions for functionality(ies) and/or model(s) are considered at least from the following aspects: information regarding model inference, a Set A or Set B configuration, performance monitoring, data collection and assistance information.

For BM-Case 1 and BM-Case 2, for model training, training data may be generated by the first apparatus 110 or the second apparatus 120. For model inference at the second apparatus 120, input data may be generated by the first apparatus 110 and transmitted to the second apparatus 120 by the first apparatus 110. For model inference at the first apparatus 110, input data is internally available at the first apparatus 110. For performance monitoring at the second apparatus 120, calculated performance metrics (if needed) or data needed for performance metric calculation (if needed) can be generated by the first apparatus 110 and transmitted to the second apparatus 120 by the first apparatus 110.

FIG. 2 illustrates a schematic diagram of an example model inference process 200 for beam management. As shown in FIG. 2, measurements based on Set B of beams are used as a model input 205 of an AL/ML model 210. In addition, information of a beam ID may be also provided as the model input 205 to the AI/ML model 210. Based on a model output 215 (e.g., a probability of each beam in Set A to be the Top-1 beam, predicted L1-RSRPs), Top-1/N beam(s) among Set A of beams may be predicted and/or potentially with predicted L1-RSRPs (depending on the labelling). In the evaluation, for BM-Case 1, the measurements of Set B may be used as the model input 205 to predict Top-1/N beams from Set A, and for BM-Case 2, the measurements from historic time instance(s) may be used as the model input 205 for temporal beam prediction of beams from Set A. In the evaluation, the cases that Set A and Set B are different (Set B is not a subset of Set A), and Set B is a subset of Set A for both BM-Case1 and BM-Case2 are considered. The case that Set A and Set B are the same for BM-Case 2 are also considered. Furthermore, the performance of a Tx beam prediction and a Tx-Rx beam pair prediction may be evaluated.

For both BM-Case1 and BM-Case2, the first apparatus 110 may report the prediction result to the second apparatus 120 based on the output of a model at the first apparatus 110 (e.g., a UE-side model in the case that the first apparatus 110 operates as a UE). Alternatively, the second apparatus 120 may predict the Top-1/N beam(s) based on the reported measurements of Set B for a model at the second apparatus 120 (e.g., a NW-side model in the case that the second apparatus 120 operates as a gNB).

For the UE-side model, different options for content in the report of inference results for BM-Case1 may be supported. Beam information on predicted Top N beam(s) among a set of beams, and beam information on the predicted top N beam(s) among a set of beams and reference signal receiving powers (RSRPs) of the predicted top N beam(s) among a set of beams may be included in the report, where the set of beams is Set A, i.e., the beams for UE prediction.

Other information in the report is for further study with a potential selection among the following options. In one option, beam information on predicted top N beam(s) among a set of beams may be included in the report. Probability information of the predicted top N beam(s) among a set of beams may also be included in the report. A quantization approach of probability information is for further study. The probability information is the probability of the beam to be the Top 1 or Top N beam. In another option, beam information on predicted top K beam(s) among a set of beams may be included in the report. In addition, RSRP(s) of the predicted Top N beam(s) among a set of beams, and confidence information of the RSRP(s) may be included in the report.

A cell switch may occur when the first apparatus 110 moves or signal conditions change. During the process of moving from the source cell 102 to the candidate cell 104, the first apparatus 110 may switch from the source cell 102 to the candidate cell 104 to maintain stable communication.

Cell switch delay requirements for layer 1(L1)/layer 2 (L2) triggered mobility (LTM) has been defined for a primary cell (PCell) switch and a primary secondary cell (PSCell) switch. A cell switch delay is a time period from the first apparatus 110 receiving a cell switch command until the first apparatus 110 sends the first UL transmission on a target cell (e.g., the candidate cell 104). The first UL transmission may be a random access channel (RACH) preamble transmission (e.g., a RACH-based cell switch), or a radio resource control (RRC) reconfiguration complete transmission (e.g., a RACH-less cell switch). The cell switch delay requirements are applicable under certain conditions.

The purpose of the LTM cell switch is to switch the PCell or PSCell to a target cell indicated in an LTM cell switch command. The requirements of the LTM cell switch delay are applicable to standalone (SA) and NR-dual connectivity (DC), and applicable to both an intra-frequency LTM cell switch and an inter-frequency LTM cell switch. The requirements for the inter-frequency cell switch are applicable, when the second apparatus 120 has configured the first apparatus 110 to perform a synchronization signal block (SSB) based L3 measurement with beam measurement reporting or an L1 measurement for the target cell before the cell switch command. The requirements for the inter-frequency cell switch are also applicable when a system frame number (SFN) of the serving cell from which the cell switch command is received and the SFN of the target cell are the same.

The cell switch delay requirements are applicable to SA for a PCell switch to a neighbouring LTM candidate cell, including a switch from a frequency range 1 (FR1) cell to an FR1 cell, a switch from an FR1 cell to an FR2 cell, a switch from an FR2 cell to an FR2 cell and a switch from an FR2 cell to an FR1 cell. The requirements are also applicable to SA for a PCell switch to an LTM candidate cell that is a serving secondary cell (SCell) in a master cell group (MCG), including a switch from an FR1 cell to an FR1 cell and a switch from an FR2 cell to an FR2 cell. The cell switch delay requirements are applicable to NR-DC for a PCell switch to a neighbouring LTM candidate cell, including a switch from an FR1 cell to an FR1 cell. The requirements are also applicable to NR-DC for a PCell switch to an LTM candidate cell that is a serving SCell in MCG, including a switch from an FR1 cell to an FR1 cell.

The cell switch delay requirements are applicable when the target cell is known. If the target cell is known, the first apparatus 110 may not need to spend time searching for it. In addition, the first apparatus 110 may synchronize and align signals on the target cell more quickly. In addition, the cell switch delay requirements are applicable when a target joint UL/DL TCI state or separate UL and DL TCI states in the MAC-CE LTM cell switch command are known, or the target cell is an FR1 cell and the first apparatus 110 has reported an L3-RSRP measurement result with an SSB index associated to the target TCI state within a time period, e.g., 5 seconds before receiving the LTM cell switch command, and a signal-to-noise ratio (SNR) of the SSB associated to the target TCI state is above a threshold quality, e.g., ≥−3 dB.

The target cell in the LTM cell switch command is known if the following condition are met. During the last 5 seconds before the reception of the cell switch command, the first apparatus 110 has sent a valid L1 or L3 measurement report for the target cell, and one of the SSBs measured from the target cell configured for measurement remains detectable according to cell identification conditions. Otherwise, the target cell is unknown.

The target joint DL/UL TCI state or separate DL and UL TCI states in the LTM cell switch command are known if the one or more of the following conditions are met. A first condition is that during the period from the last transmission of the reference signal (RS) resource used for the L1-RSRP measurement reporting for the target DL/UL TCI state to the completion of an LTM cell switch, where the RS resource for an L1-RSRP measurement is the RS in target DL/UL TCI state or quasi co-located (QCLed) to the target DL/UL TCI state. A second condition is that the LTM cell switch command is received within a time period, e.g., 1280 milliseconds upon the last transmission of the RS resource for beam reporting or measurement. A third condition is that the first apparatus 110 has sent at least one L1-RSRP report for the target DL/UL TCI state before the LTM cell switch command. A fourth condition is that the target DL/UL TCI state remains detectable during the LTM cell switching period. A fifth condition is that the SSB associated with the target DL/UL TCI state remains detectable during the cell switching period. A sixth condition is that the SNR of the TCI state is above a threshold quality, e.g., ≥−3 dB. Otherwise, the target joint DL/UL TCI state or separate DL and UL TCI state is unknown.

For a model at the first apparatus 110 (e.g., a UE-side model), the first apparatus 110 may be configured to report the beam prediction result, and the second apparatus 120 may indicate and/or activate a TCI state corresponding to the predicted beams of the candidate cell 104 e.g., from Set A2. Set A2 includes beams for prediction associated with the candidate cell 104. The first apparatus 110 may predict performances of the beams in Set A2 based on a measurement of Set B2, which includes beams for measurement associated with the candidate cell 104. Alternatively, the second apparatus 120 may indicate and/or activate a TCI state corresponding to the predicted beams of the source cell 102 e.g., from Set A1 when indicating and/or activating the TCI state corresponding to the predicted beams of the candidate cell 104. Set A1 includes beams for prediction associated with the source cell 102. The first apparatus 110 may predict performances of the beams in Set A1 based on a measurement of Set B1, which includes beams for measurement associated with the source cell 102. The predicted beams may be within Set A2 configured for one or more than one candidate cell. Set B2 is a subset of Set A2 and Set B1 is a subset of Set A1.

For a model at the second apparatus 120 (e.g. a NW-side model), the first apparatus 110 may be configured to report the beam measurement result of beams from Set B2 (or Set B1). For the NW-sided model that predicts beams based on measurement results, the second apparatus 120 may need to indicate and/or activate a TCI state corresponding to the predicted beams from Set A2 (or Set A1).

In view of the above, the issue considered in the present disclosure is related to the intercell beam prediction where the first apparatus 110 (e.g., with the UE-side ML model) or the second apparatus 120 (e.g., with the NW-side ML model) is configured to predict the beams (or DL RS resources) from the candidate cell 104 (or a serving cell). For LTM, when the TCI state is activated and/or indicated based on the prediction of the candidate cell, the first apparatus 110 may have not measured the RS resource corresponding to the indicated or activated TCI state since the RS resource of the candidate cell 104 may be predicted from a prediction resource set of the candidate cell 104 based on a measurement resource set. The prediction resource set of the candidate cell 104 includes RS resources to be predicted, which may correspond to Set A2. The prediction resource set of the candidate cell 104 includes RS resources to be measured, which may correspond to Set B2. The RS may be predicted rather than measured and thus the TCI state may be unknown. In this case, the indicated TCI state may cause the first apparatus 110 to apply a switching delay based on an unknown status of the TCI state (which may also be assumed by the second apparatus 120).

Similarly, as described above, cell switch delay requirements also require that the candidate cell 104 to be known if the first apparatus 100 performs at least one L1 or L3 measurement associated with the candidate cell 104 and reports to the second apparatus 120. However, if the cell switch decision is made based on predictions (or predicted measurements), such L1 or L3 measurements and corresponding reports may not be available, resulting in the candidate cell 104 being unknown.

It is not defined whether condition(s) for determining a known cell based on a beam prediction may be interpreted in the same way from condition(s) for determining a known cell related to cell switch delay requirements described above. Alternatively, or in addition, it is not defined whether condition(s) for determining a known TCI state based on a beam prediction may be interpreted in the same way from condition(s) for determining a known TCI state related to cell switch delay requirements described above.

In accordance with some example embodiments, a solution for determination of a known cell is proposed. In some example embodiments, a first apparatus 110 receives, from a second apparatus 120, a cell switch command indicating the first apparatus 110 to switch to a candidate cell 104. After receiving the cell switch command, the first apparatus 110 switches from a source cell 102 to the candidate cell 104, based on the candidate cell 104 being known. The candidate cell 104 is determined to be known according to a prediction associated with the candidate cell 104.

With this solution, conditions for the candidate cell 104 being known are defined by taking AI/ML-based beam prediction into consideration. The determination of the candidate cell 104 is known may be according to the prediction associated with the candidate cell 104. In this way, the accuracy of determining that the candidate cell 104 is known may be improved and the efficiency for the first apparatus to switch to the candidate cell 104 may also be improved.

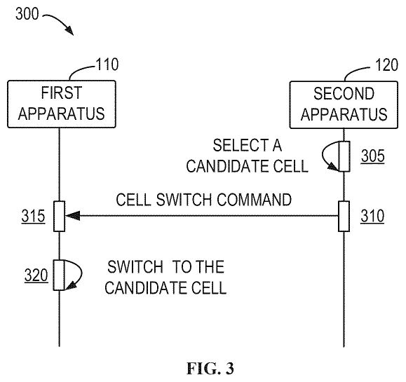

FIG. 3 illustrates a signaling flow of an example process 300 of determination of a known cell in accordance with some example embodiments of the present disclosure. The process 300 involves the first apparatus 110 and the second apparatus 120, which will be described with reference to FIG. 1.

As shown in FIG. 3, the second apparatus 120 transmits (310), to the first apparatus 110, a cell switch command indicating the first apparatus 110 to switch to the candidate cell 104. Correspondingly, the first apparatus 110 receives (315) the cell switch command. In some examples, the cell switch command may include information of the candidate cell 104 (e.g., an identity and a frequency of the candidate cell 104). Based on the information of the candidate cell 104, the first apparatus 110 may identify the candidate cell 104 for preparation of switching to the candidate cell 104.

After receiving (315) the cell switch command, the first apparatus 110 switches (320) from a source cell 102 to the candidate cell 104. The switching is based on the candidate cell 104 being known (or applicable) according to a prediction associated with the candidate cell 104. The prediction associated with the candidate cell 104 may include a prediction of any suitable quantity, performance metric or information of the candidate cell 104.

In some example embodiments, the prediction associated with the candidate cell 104 may include a prediction of at least one beam associated with the candidate cell 104. In an example, the at least one beam may be beams with high signal qualities among a set of beams associated with the candidate cell 104.

Alternatively, or in addition, the prediction associated with the candidate cell 104 may further include a prediction of at least one RS. In some examples, the RS may include an SSB, a channel state information (CSI)-RS, a demodulation reference signal (DMRS) and the like. One RS corresponds to one beam and the RS is determined by the beam. For example, the prediction associated with the candidate cell 104 may include a prediction of a signal quality of a RS associated with the candidate cell 104. In some examples, the prediction of the signal quality may include a predicted L1-RSRP, a predicted L3-RSRP, a predicted received signal strength indicator (RSSI), a predicted reference signal received quality (RSRQ), a signal-to-interference-plus-noise ratio (SINR) and the like of the RS.

The prediction associated with the candidate cell 104 may be performed by a machine learning model at the first apparatus 110 or at the second apparatus 120. If the machine learning model is at the first apparatus 110, the first apparatus 110 may perform measurements on the measurement resource set and apply the machine learning model to predict RSs from the prediction resource set or predict beams from Set A2. If the machine learning model is at the second apparatus 110, the first apparatus 110 may perform measurements on the measurement resource set and transmit the measurement results to the second apparatus 120. Then, the second apparatus 120 may apply the machine learning model to predict RSs from the prediction resource set or beams from Set A2.

In some example embodiments, in the case that the machine learning model is deployed at the first apparatus 110, the first apparatus 110 may apply the machine learning model to predict a first beam (e.g., a beam with high signal quality) of the candidate cell 104, apply the machine learning model to obtain a first predicted signal quality of an RS related to the first predicted beam and transmit, to the second apparatus 120, a report containing information related to the prediction associated with candidate cell 104 (e.g., the first predicted beam and the first predicted signal quality). Correspondingly, the second apparatus 120 may receive the report. Then, as shown in FIG. 3, the second apparatus 120 selects (305) a candidate cell 104 for the first apparatus 110, for example, based on the report and transmits (310) the cell switch command indicating the candidate cell 104 to the first apparatus 110. In some examples, the second apparatus 120 may obtain signal qualities of different cells measured or predicted by the first apparatus 110 and select a cell with the highest signal quality as the candidate cell. In some examples, the first apparatus 110 may be configured with the measurement resource set of the candidate cell 104 to predict RSs from the prediction resource set of the candidate cell 104 or beams from Set A2. The first apparatus 110 may be configured to report up to N2 (where N2 is a positive integer) predicted RSs of the candidate cell 104. The first apparatus 110 may perform measurements on the measurement resource set of the candidate cell 104 and apply the machine learning model to perform prediction based on the measurement result. Then, the first apparatus 110 may report, to the second apparatus 120, N2 predicted RSs from the prediction resource set of the candidate cell 104 or N2 predicted beams from Set A2.

In addition to performing prediction for the candidate cell 104, the prediction for source cell may also be performed. In some example embodiments, the first apparatus 110 may apply the machine learning model to predict at least one second beam of the source cell and apply the machine learning model to obtain a second predicted signal quality related to the second predicted beam. The report may further contain information related to the second predicted beam and the second predicted signal quality. In some examples, the first apparatus 110 may predict Top-N1 (where N1 is a positive integer) RSs or beams of the source cell 102, the first apparatus 110 may be configured with the measurement resource set of the source cell 102 used for prediction from prediction resource set of the serving cell. The first apparatus 110 may perform measurements on the measurement resource set of the source cell 102 and perform prediction based on the measurement result. Then, the first apparatus 110 may report, to the second apparatus 120, N1 predicted RS from the prediction resource set of the source cell 102 or N1 predicted beams from Set A1. In some examples, the measurement resource set and the prediction resource set may be configured by the second apparatus 120 to the first apparatus 110.

In some example embodiments, the first apparatus may determine that the candidate cell 104 is known, for example, based on one or more conditions. The conditions may comprise a condition that a predicted RS associated with the candidate cell 104 is included in a set of RSs to be measured (also referred to as the measurement resource set) for the candidate cell 104. The predicted RS associated with the candidate cell 104 may be predicted by the first apparatus 100 using the machine learning model. If the predicted RS associated with the candidate cell 104 is included in the set of RSs to be measured for the candidate cell 104, a measurement (e.g., an L1-RSRP measurement or an L3-RSRP measurement) of the predicted RS may have been performed by the first apparatus 110 and a measurement result may be obtained. Therefore, the candidate cell 104 may be known to the first apparatus 110 based on the measurement result of the predicted RS.

Alternatively, or in addition, the conditions may comprise a condition that a report of the first apparatus 110 contains information related to the prediction associated with the candidate cell 104. If the first apparatus 110 has measured an RS or beam contained in the prediction associated with the candidate cell 104, the first apparatus 110 may transmit, to the second apparatus 120, a report containing the measurement result related to prediction associated with the candidate cell 104. The first apparatus 110 may determine that the candidate cell 104 based on the measurement result. In this case, the candidate cell 104 may be considered to be known to the first apparatus 110.

In some example embodiments, the first apparatus 110 may determine that the candidate cell 104 is known if the following condition is met. The condition is that the report of the first apparatus 110 is transmitted within a time duration before the cell switch command is received. The time duration may have any time length, for example, 50 millisecond, 5 seconds and the like. If the first apparatus 110 has transmitted, to the second apparatus 120, the report within the last several milliseconds (or other time units such as symbols or slots) before the reception of the cell switch command, the first apparatus 110 may still keep the measurement result of the RS or beam contained in the prediction associated with candidate cell 104. In this case, the candidate cell 104 may be considered to be known to the first apparatus 110.

Alternatively, or in addition, the first apparatus 110 may determine that the candidate cell 104 is known if the following condition is met. The condition indicates that a first predicted signal quality of a RS associated with the candidate cell 104 is greater than or equal to (for example, above) a first threshold quality. The first threshold quality may be configured semi-persistently or dynamically. In some examples, the first threshold quality may be determined based on information of reliable radio connections. In some example embodiments, the predicted signal quality of the RS may include at least one of a predicted L1-RSRP or a predicted L3-RSRP of the RS. If a predicted (and reported) signal quality for an RS associated with the candidate cell 104 is predicted to be above a threshold quality, the predicted signal quality may be considered to be reliable enough. In this case, the candidate cell 104 may be considered to be known to the first apparatus 110.

Alternatively, or in addition, the first apparatus 110 may determine that the candidate cell 104 is known if the following condition is met. The condition indicates that a second predicted signal quality corresponding to a predicted beam associated with the candidate cell being greater than or equal to a second threshold quality, where the predicted beam may be predicted by the first apparatus 110 by using the machine learning model. The second threshold quality may be configured semi-persistently or dynamically. In some examples, the second threshold quality may be determined based on information of reliable radio connections. In some example embodiments, the predicted signal quality corresponding to the predicted beam may include at least one of a predicted L1-RSRP or a predicted L3-RSRP. If a predicted (and reported) signal quality corresponding to a predicted beam associated with the candidate cell is predicted to be above a threshold quality, the predicted signal quality may be considered to be reliable enough. In this case, the candidate cell 104 may be considered to be known to the first apparatus 110.

Alternatively, or in addition, the first apparatus 110 may determine that the candidate cell 104 is known if the following condition is met. The condition is that a prediction accuracy of the prediction associated with the candidate cell 104 is greater than or equal to a threshold accuracy. The threshold accuracy may be configured semi-persistently or dynamically. The prediction accuracy of the machine learning model may indicate the prediction accuracy of the prediction associated with the candidate since the machine learning model performs prediction associated with the candidate cell 104. If a prediction accuracy of a machine learning model used for prediction is above a threshold accuracy (e.g., 95%), most predictions associated with the candidate cell 104 predicted by the machine learning model may be correct. In this case, the candidate cell 104 may be considered to be known to the first apparatus 110.

In some example embodiments, if none of the above conditions for the candidate cell 104 being known is met, the candidate cell 104 may be unknown. The first apparatus 110 may not switch to the candidate cell 104 based on the candidate cell 104 being unknown.

A difference between a predicted L1-RSRP for a beam and an actual measured L1-RSRP for the beam (also referred to as an L1-RSRP difference) may be used for determining the prediction accuracy of the prediction associated candidate cell 104. In some example embodiments, the prediction accuracy of the prediction associated candidate cell 104 may be determined based on some metrics, such as a prediction accuracy of top-N predicted beams or the L1-RSRP difference. In an example, the prediction accuracy of top-N predicted beams may be obtained by comparing the top-N predicted beams with top-N actual measured beams. The higher the prediction accuracy of top N predicted beams, the higher the prediction accuracy of the prediction associated candidate cell 104. The smaller the L1-RSRP difference, the higher the prediction accuracy of the prediction associated candidate cell 104.

In some example embodiments, when the second apparatus 120 selects (305) the candidate cell 104 for the first apparatus 110, the second apparatus 120 may determine that the candidate cell 104 is known to the first apparatus 110 according to the prediction associated with the candidate cell 104. In some example embodiments, the candidate cell 104 may be known based on at least one of: a predicted reference signal associated with the candidate cell 104 being included in a set of reference signals to be measured for the candidate cell 104, a report of the first apparatus containing information related to the prediction associated with the candidate cell 104, a first predicted signal quality of a reference signal associated with the candidate cell 104 being greater than or equal to a first threshold quality, a second predicted signal quality corresponding to a predicted beam associated with the candidate cell being greater than or equal to a second threshold quality, or a prediction accuracy of the prediction associated with the candidate cell 104 being greater than or equal to a threshold accuracy. The approach of determining that the candidate cell 104 is known described with reference to the first apparatus 110 may be also applicable to the second apparatus 120. The details of the second apparatus 120 determining that the candidate cell 104 is known is not repeated here again.

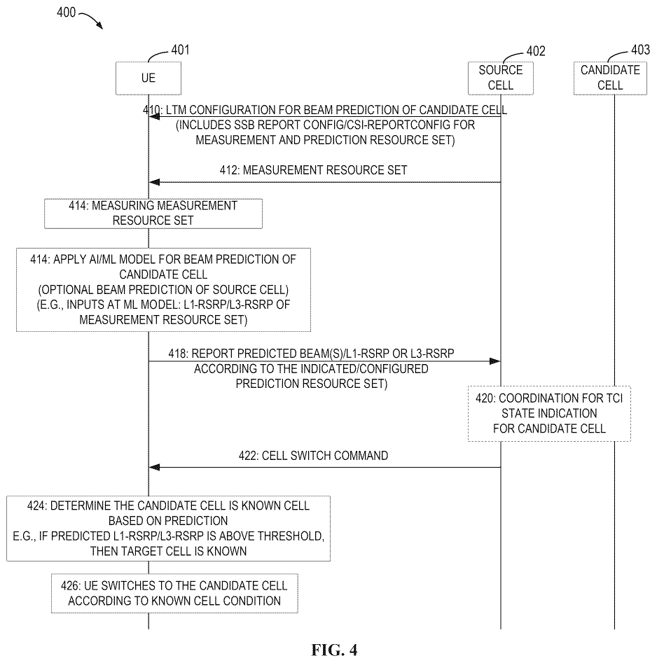

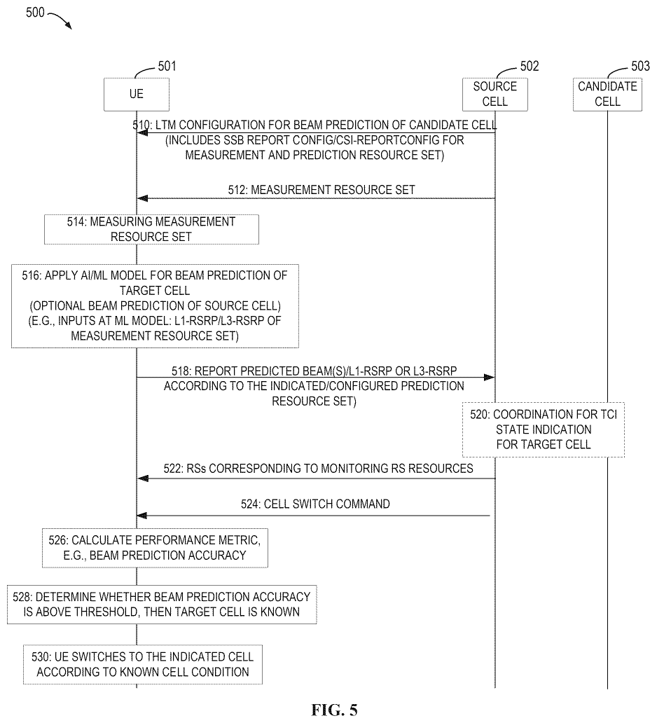

Example processes of determination of a known cell will be introduced with reference to FIG. 4 and FIG. 5. Reference is first made to FIG. 4 which illustrates an example signaling flowchart of an example process 400 of determination of a known cell in accordance with some example embodiments of the present disclosure. In this example, a UE 401 is an example of the first apparatus 110, a source cell 402 is an example of the source cell 102 and a candidate cell 403 is an example of the candidate cell 104. A UE-side model is used for the prediction associated with a cell.

As shown in FIG. 4, the UE 401 may receive (410), from the source cell 402, an LTM configuration for beam prediction of candidate cell(s). In an example, the LTM configuration may include a SSB ReportConfig or a channel state information (CSI) ReportConfig for measurement. The SSB ReportConfig is used to define the configuration for reporting measurements related to the SSB. CSI-ReportConfig is used to define the configuration for reporting measurements related to the CSI. The SSB and the CSI are a kind of RS. In addition, the LTM configuration also include prediction resource sets of the candidate cell(s) and the source cell 402. A configuration or indication of measurement resource sets of the candidate cell(s) and the source cell 402 is received (412) by the UE 401 from the source cell 402.

After receiving the measurement resource sets, the UE 401 may measure (414) RSs in the measurement resource set of the candidate cell(s) firstly. Then, the UE 401 may apply (416) an AI/ML model (which is a UE-side model) for prediction of the candidate cell(s) based on measurements (e.g., the L1-RSRP or the L3-RSRP) on the measurement resource set of the candidate cell(s). In an example, the prediction of the candidate cell(s) may include a prediction of at least one beam associated with the candidate cell(s) and a prediction of a signal quality (e.g., the L1-RSRP or the L3-RSRP) related to the at least one beam. In addition to perform prediction the candidate cell(s), the prediction for the source cell 402 may also be performed. The UE 401 may apply (416) the AI/ML model for the prediction of the source cell 402 based on measurements on the measurement resource set of the source cell 402.

After performing the prediction, the UE 401 may report (418) the predicted beam(s) and the predicted signal qualities, according to the prediction resource sets, to the source cell 402. Based on the report, the source cell 402 may select the candidate cell 403 for the UE 401. In addition, the source cell 402 and the candidate cell 403 may perform (420) a coordination for a TCI state indication for the candidate cell 403. The TCI state may be used to indicate the beam to be used for the candidate cell 403.

The UE 401 may receive (422), from the source cell 402, a cell switch command indicating the UE 401 to switch to the candidate cell 403. The UE 401 may determine (424) whether the candidate cell 403 is a known cell based on prediction associated with the candidate cell 403. For example, if the predicted signal quality (L1-RSRP or L3-RSRP) of a RS associated with the candidate cell 403 is greater than or equal to a threshold quality, the candidate cell 403 may be known. Then, the UE 401 may switch (426) to the candidate cell 403 based on the candidate cell 403 being known.

FIG. 5 illustrates an example signaling flowchart of another example process 500 of determination of a known cell in accordance with some example embodiments of the present disclosure. In this example, a UE 501 is an example of the first apparatus 110, a source cell 502 is an example of the source cell 102 and a candidate cell 503 is an example of the candidate cell 104.

In the process 500, steps 510 to 520 are similar with the steps 410 to 420, and details thereof will not be repeated. In the example process 500, the UE 501may determine that the candidate cell 503 is known based on the prediction accuracy of the prediction associated with the candidate cell 503 rather than the predicted signal quality.

As shown in FIG. 5, the UE 501 may receive (522), from the source cell 502, RSs corresponding to monitoring RS resources. The UE 501 may monitor the quality of radio link using the RSs. In addition, the UE 501 may receive (524), from the source cell 502, a cell switch command indicating the UE 501 to switch to the candidate cell 503.

The UE 501 may calculate (526) the performance metric (e.g., a prediction accuracy) of the prediction associated with the candidate cell 503. The prediction accuracy may be determined on the accuracy of predicted beams and L1-RSRP difference. After determining the prediction accuracy, the UE 501 may determine (528) whether the candidate cell 503 is known based on the prediction accuracy. In an example, if the prediction accuracy is greater than or equal to a threshold accuracy, the candidate cell 503 is known. Then, the UE 501 may switch (530) to the candidate cell 503 based on the candidate cell 503 being known.

Some other example embodiments provide a solution for determination of a known TCI state. In some example embodiments, a first apparatus 110 receives, from a second apparatus 120, at least one of an activation command or an indication for a candidate TCI state associated with a candidate cell 104. The first apparatus 110 receives, from the second apparatus 120, a cell switch command indicating the first apparatus to switch to the candidate cell 104. In response to receiving the cell switch command, the first apparatus switches from a source cell 102 to the candidate cell 104 using the candidate TCI state, based on the candidate TCI state being known or unknown. The determination of the candidate TCI state being known or unknown is according to a prediction associated with the candidate cell 104.

With this solution, conditions for the candidate TCI state being known are defined by taking AI/ML-based beam prediction into consideration. The determination of the candidate TCI state being known or unknown may be based on the prediction associated with the candidate cell. In this way, the accuracy of determining that the candidate TCI state being known or unknown may be improved and the efficiency for the first apparatus to switch to the candidate cell using the candidate TCI state may also be improved.

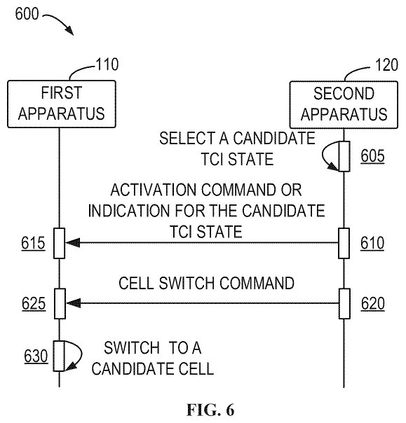

FIG. 6 illustrates a signaling flow of an example process 600 of determination of a known TCI state in accordance with some example embodiments of the present disclosure. The process 600 involves the first apparatus 110 and the second apparatus 120, which will be described with reference to FIG. 1.

As shown in FIG. 6, the second apparatus 120 transmits (610), to the first apparatus 110, at least one of an activation command or an indication for a candidate TCI state for a candidate cell. Correspondingly, the first apparatus 110 receives (615) the activation command or the indication. In some examples, the activation command or the indication may be transmitted via a medium access control (MAC) control element (CE), downlink control information (DCI) or an RRC message.

Further, the second apparatus 120 transmits (620), to the first apparatus 110, a cell switch command indicating the first apparatus 110 to switch to the candidate cell 104. Correspondingly, the first apparatus 110 receives (625) the cell switch command. In some examples, the cell switch command may include information of the candidate cell 104 (e.g., an identity and a frequency of the candidate cell 104). Based on the information of the candidate cell 104, the first apparatus 110 may identify the candidate cell 104 for preparation of switching to the candidate cell 104.

After receiving (625) the cell switch command, the first apparatus 110 switches (630) from a source cell 102 to the candidate cell 104 using the candidate TCI state. The switching is based on the candidate TCI state being known or unknown according to a prediction associated with the candidate cell 104. In some examples, if the candidate TCI state is unknown, an additional switching time may be required for the first apparatus 110 to switch from the source cell to the candidate cell 104.

In some example embodiments, the first apparatus 110 may determine that the candidate TCI state is known based on one or more conditions. In some examples, the candidate TCI state may indicate a Quasi-Colocation (QCL) relationship between one or two downlink RSs and the QCL relationship may indicate a beam for the first apparatus 110 to use. The first apparatus 110 may switch to the candidate cell 104 by switching to the beam indicated by the candidate TCI state. The conditions may comprise a condition that a predicted RS associated with the candidate TCI state is included in a set of RSs to be measured for the candidate cell. The predicted RS associated with the candidate cell may be predicted by the first apparatus 100 using the machine learning model. In an example, the predicted RS may include a predicted QCL source RS corresponding indicated by the candidate TCI state. The QCL source RS indicated by the candidate TCI state may be the RS used to define a QCL relationship with another RS and the QCL relationship helps the first apparatus 110 to align its receive beam with the transmit beam of the second apparatus 120 for better signal reception. The QCL source RS may include an SSB, a channel state information (CSI)-RS and the like. If the predicted QCL source RS is included in the set of RSs to be measured of the candidate cell, a measurement (e.g., L1-RSRP or L3-RSRP) of the predicted QCL source RS may have been performed by the first apparatus 110 and a measurement result may be obtained. Therefore, the candidate TCI state may be known to the first apparatus 110 if the predicted QCL source RS has been measured by the first apparatus 110.

Alternatively, or in addition, the first apparatus 110 may determine that the candidate TCI state is known if the following condition is met. The condition is that a measured signal quality of a RS of the set of RSs to be measured is greater than or equal to (for example, above) a first threshold quality. In some examples, the measured signal quality of the RS may include at least one of: a L1-RSRP, a L3-RSRP and a signal to interference plus noise ratio (SINR). If the measured signal quality of the RS associated with the candidate cell is above a threshold quality, the RS may be considered to be reliable enough. In this case, the candidate TCI state may be considered to be known to the first apparatus 110.

Alternatively, or in addition, the first apparatus 110 may determine that the candidate TCI state is known if the following condition is met. The condition is that a predicted signal quality of a RS associated with the candidate cell is greater than or equal to a second threshold quality. In some example embodiments, the predicted signal quality of the RS may include at least one of a predicted L1-RSRP or a predicted L3-RSRP of the RS. If a predicted (and reported) signal quality for an RS associated with the candidate cell is predicted to be above (for example, greater than or equal to) a preconfigured or predefined threshold level, the predicted signal quality may be considered to be reliable enough. In this case, the candidate TCI state may be considered to be known to the first apparatus 110.

Alternatively, or in addition, the first apparatus 110 may determine that the candidate TCI state is known if the following condition is met. The condition is that a prediction accuracy of the prediction associated with the candidate cell is greater than or equal to a threshold accuracy. If a prediction accuracy associated with the candidate cell that determines the prediction accuracy of a machine learning model used for prediction is above a threshold level (e.g., 95%), most predictions associated with the candidate cell predicted by the machine learning model may be correct. In this case, the candidate TCI state may be considered to be known to the first apparatus 110.

In some example embodiments, instead of transmitting an activation command or an indication of the candidate TCI state and the cell switch command separately, for example, in two different messages, the cell switch command may indicate the candidate TCI state. In some example embodiments, the first apparatus 110 may determine that the candidate TCI state is known if the following condition is met. The condition is that the cell switch command contains the candidate TCI state and is received within a first time duration after a RS for the prediction associated with the candidate cell is transmitted. The first time duration may have a time length such as 50 milliseconds or 5 seconds and the first time duration may be configured semi-persistently or dynamically. In some examples, if the cell switch command containing the candidate TCI state is received within a predefined time duration (e.g., the first time duration) upon the last transmission of the RS resource (e.g., the RS for the prediction associated with the candidate cell) for beam reporting or measurement and the RS resource is configured in the prediction resource set of the candidate cell, the first apparatus 110 may obtain enough information by measuring the RS resource within the time duration. In this case, the candidate TCI state may be known to the first apparatus 110.

Alternatively, or in addition, the first apparatus 110 may determine that the candidate TCI state is known if the following condition is met. The condition indicates that the cell switch command contains the candidate TCI state and is received within a second time duration after a reference signal for a predicted beam of the candidate cell is transmitted. The second time duration may have a time length such as 50 milliseconds or 5 seconds and the second time duration may be configured semi-persistently or dynamically. In some examples, if the cell switch command containing the candidate TCI state is received within a predefined time duration (e.g., the second time duration) upon the last transmission of the RS resource (e.g., the RS for predicted beam reporting or predicted L1/L3-RSRP corresponding to the predicted beam) and the RS resource is configured in the prediction resource set of the candidate cell, the first apparatus 110 may obtain enough information by measuring the RS resource within the time duration. In this case, the candidate TCI state may be known to the first apparatus 110.

In some example embodiments, the first time duration or the second time duration may be less than a prediction duration for the candidate cell. Alternatively, or in addition, the first time duration or the second time duration may be larger than a measurement and reporting duration for the candidate cell. In an example, the measurement and reporting duration may be used for non-prediction based TCI state switching. In the non-prediction-based TCI state switching, the first apparatus 110 may measure the performance of all beams rather than predict the performance of most beams based on the measurement result of few beams. Then, the first apparatus 110 may report the measurement result of all beams to the second apparatus 120, which may indicate a beam for the first apparatus 110 to use based on the report.

Alternatively, or in addition, the first apparatus may determine that the candidate TCI state is known if the following condition is met. The condition indicates that the cell switch command containing the candidate TCI state and being received within a third time duration after a report of the first apparatus 110 regarding the prediction associated with the candidate cell is transmitted. If the cell switch command containing the TCI state is received within several milliseconds (or other time unit like symbols, slots or seconds) after prediction associated with the candidate cell being reported by the first apparatus 110, the first apparatus 110 may still keep the prediction. In this case, the candidate cell may be considered to be known to the first apparatus 110. If any one of the above conditions for the candidate TCI state being known is not met, the candidate TCI state may be unknown.

In some example embodiments, the first apparatus 110 may apply the candidate TCI state based on a switching time according to a switching delay, where the switching delay is based on the candidate TCI state being known or unknown. Based on the determination whether the candidate TCI state known or unknown, the first apparatus 110 may perform a TCI state switch or cell switch, that is, applying the candidate TCI state based on the switching time according to the known or unknown switching delay. The switching delay may vary based on the candidate TCI state being known or unknown. If the candidate TCI state is unknown, an additional switching delay may be required because the first apparatus 110 may not have enough information of the beam for switching to the candidate cell 104.

In some example embodiments, the second apparatus 120 selects (605) the candidate TCI state for the candidate cell. The selection may consider that the candidate TCI state is known or unknown to the first apparatus, according to a prediction associated with the candidate cell. In some example embodiments, the candidate TCI state may be known based on at least one of: a predicted reference signal associated with the candidate TCI state being included in a set of reference signals to be measured for the candidate cell, a measured signal quality of a reference signal of the set of reference signals being greater than or equal to a first threshold quality, a predicted signal quality of a reference signal associated with the candidate cell being greater than or equal to a second threshold quality, a prediction accuracy of the prediction associated with the candidate cell being greater than or equal to a threshold accuracy, the cell switch command containing the candidate TCI state and being received within a first time duration after a reference signal for the prediction associated with the candidate cell is transmitted, the cell switch command containing the candidate TCI state and being received within a second time duration after a reference signal for a predicted beam of the candidate cell is transmitted, or the cell switch command containing the candidate TCI state and being received within a third time duration after a report of the first apparatus regarding the prediction associated with the candidate cell is transmitted. The approach of determining that the candidate TCI state is known described with reference to the first apparatus 110 may be also applicable to the second apparatus 120. The details of the second apparatus 120 determining that the candidate TCI state is known is not repeated here again.

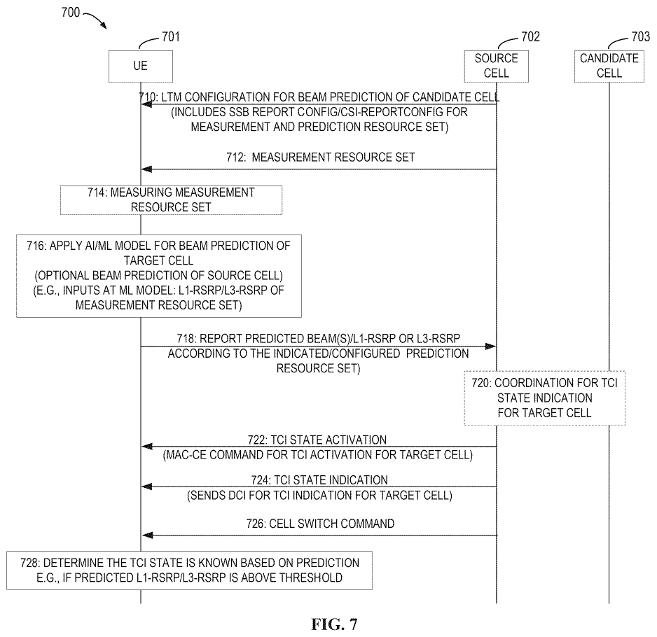

An example process of determination of a known TCI state may be introduced with reference to FIG. 7, which illustrates an example signaling flowchart of an example process 700 of determination of a known TCI state in accordance with some example embodiments of the present disclosure. In this example, a UE 701 is an example of the first apparatus 110, and a source cell 702 is an example of source cell 102 and a candidate cell 703 is an example of candidate cell 104. A UE-side model is used in the process 700.

Steps 710 to 720 are similar with steps 410 to 420, and details thereof will not be repeated. As shown in FIG. 7, in the example process 700, the UE 701 may determine that the candidate TCI that is known. The UE 701 may receive (722), from the source cell 702, a TCI state activation (e.g., an activation command for a candidate TCI state) via a MAC-CE command for activation of a candidate TCI state associated with the candidate cell 703. The UE 701 may receive (724), from the source cell 702, a TCI state indication (e.g., an indication for the candidate TCI state) via a DCI to indicate a candidate TCI state associated with the candidate cell 703. In addition, the UE 703 may receive (726), from the source cell 702 a cell switch command indicating the UE 701 to switch to the candidate cell 703.

The UE 701 may determine (728) whether the candidate TCI state is known based on the prediction associated with the candidate cell 703. In an example, if a predicted signal quality of a RS associated with the candidate cell is greater than or equal to threshold quality, the candidate TCI may be known.

Some example embodiments provide solutions of how to determine whether a candidate cell or a candidate TCI state associated with the candidate cell is known or not. In some example embodiments, after a first apparatus 110 receives, from a second apparatus 120, a cell switch command indicating the first apparatus 110 to switch to a candidate cell 104, the first apparatus 110 determines that the candidate cell is known, according to a prediction associated with the candidate cell. One or more conditions may be used by the first apparatus 110 to determine a known cell. Based on the candidate cell 104 being known, the first apparatus switches from a source cell 102 to the candidate cell 104. In this way, the determination of the candidate cell 104 being known may be more accurate.

FIG. 8 illustrates a signaling flow of an example process 800 of determination of a known cell and TCI state in accordance with some example embodiments of the present disclosure. The process 800 involves the first apparatus 110 and the second apparatus 120, which will be described with reference to FIG. 1.

As shown in FIG. 8, the second apparatus 120 transmits (810), to the first apparatus 110, a cell switch command indicating the first apparatus 110 to switch to the candidate cell. Correspondingly, the first apparatus 110 receives (815) the cell switch command.

The first apparatus 110 determines (820) that the candidate cell is known, according to a prediction associated with the candidate cell. Some conditions may be used by the first apparatus 110 for the determining (820). One condition is that a predicted signal quality of a reference signal associated with the candidate cell is greater than or equal to a threshold quality

In some example embodiments, the conditions may be related to a report for the prediction associated with the candidate cell, transmitted by the first apparatus 110 to the second apparatus 120. For example, the first apparatus 110 may transmit, to the second apparatus 120, a report containing information related to the prediction associated with the candidate cell. The first apparatus 110 may determine that the candidate cell is known if the report is transmitted within a time duration before the cell switch command is received. The time duration may be a period such as 50 millisecond, 5 seconds and the like. If the first apparatus 110 has transmitted, to the second apparatus 120, the report within the last several milliseconds (or other time unit such as symbols or slots) before the reception of the cell switch command, the first apparatus 110 may still keep the measurement result of the RS or beam contained in the prediction associated with candidate cell. In this case, the candidate cell may be considered to be known to the first apparatus 110.

In some example embodiments, the conditions may be related to a predicted signal quality, where predicted signal quality may be output by a machine learning model. For example, the first apparatus 110 may apply a machine learning model (which is a UE-side model) to predict a beam of the candidate cell and apply the machine learning model to obtain a predicted signal quality related to the predicted beam. The first apparatus 110 may determine that the candidate cell is known if the predicted signal quality is greater than or equal to (for example, above) a threshold quality. In some examples, the machine leaning model may output the probability of each beam in the prediction resource set to be the Top-1 beam (e.g., the beam with the highest signal quality of an RS). The beam with the highest probability may be the predicted beam of the candidate cell. If a predicted (and reported) signal quality of an RS for a beam associated with the candidate cell is predicted to be above a threshold quality, the predicted signal quality may be considered to be reliable enough. In this case, the candidate cell may be considered to be known to the first apparatus 110.

In some example embodiments, the conditions may be related to a prediction accuracy of the prediction associated with the candidate cell. For example, the first apparatus 110 may determine the prediction accuracy of the prediction associated with the candidate cell. The first apparatus 110 may determine that the candidate cell is known if the prediction accuracy is greater than or equal to a threshold accuracy. The first apparatus 110 may determine the prediction accuracy based on the prediction accuracy of top-N predicted or the L1-RSRP difference. If the prediction accuracy is above a threshold level (e.g., 95%), most predictions associated with the candidate cell may be correct. In this case, the candidate cell may be considered to be known to the first apparatus 110.

In some example embodiments, the candidate cell may be known based on at least one of: a predicted reference signal associated with the candidate cell being included in a set of reference signals to be measured for the candidate cell, a report of the first apparatus containing information related to the prediction associated with the candidate cell, a predicted signal quality of a reference signal associated with the candidate cell being greater than or equal to a threshold quality, or a prediction accuracy of the prediction associated with the candidate cell being greater than or equal to a threshold accuracy. After determining that the candidate cell 104 is known, the apparatus 110 switches (840) from a source cell 102 to the candidate cell 104.

In some example embodiments, the second apparatus 120 may transmit (825), to the first apparatus 110, at least one of an activation command or an indication for a candidate TCI state associated with the candidate cell. Correspondingly, the first apparatus 110 may receive (830) at least one of the activation command or the indication for a candidate TCI state and may determine (835) whether the candidate TCI state is known or unknown, according to the prediction associated with the candidate cell. The first apparatus 110 may switch from the source cell to the candidate cell using the candidate TCI state based on the candidate TCI state being known or unknown. In an example, if the candidate TCI state is unknown, switching from the source cell to the candidate cell using the candidate TCI state may cost more time.

In some example embodiments, the first apparatus 110 may determine that the candidate TCI state is known if the following condition is met. The condition is that the cell switch command contains the candidate TCI state and is received within a first time duration after a RS for the predication associated with the candidate cell is transmitted. In some examples, if the cell switch command containing the candidate TCI state is received within a predefined time duration (e.g., the first time duration) upon the last transmission of the RS resource (e.g., the RS for the prediction associated with the candidate cell) for beam reporting or measurement and the RS resource is configured in the prediction resource set of the candidate cell, the first apparatus 110 may obtain enough information by measuring the RS resource within the time duration. In this case, the candidate TCI state may be known to the first apparatus 110.

Alternatively, or in addition, the first apparatus 110 may determine that the candidate TCI state is known if the following condition is met. The condition indicates that the cell switch command contains the candidate TCI state and is received within a second time duration after a reference signal for a predicted beam of the candidate cell is transmitted. In some examples, if the cell switch command containing the candidate TCI state is received within a predefined time duration (e.g., the second time duration) upon the last transmission of the RS resource (e.g., the RS for predicted beam reporting or predicted L1/L3-RSRP corresponding to the predicted beam) and the RS resource is configured in the prediction resource set of the candidate cell, the first apparatus 110 may obtain enough information by measuring the RS resource within the time duration. In this case, the candidate TCI state may be known to the first apparatus 110.

In some example embodiments, the candidate TCI state may be known based on at least one of: a predicted reference signal associated with the candidate TCI state being included in a set of reference signals to be measured for the candidate cell, a measured signal quality of a reference signal of the set of reference signals being greater than or equal to a first threshold quality, a predicted signal quality of a reference signal associated with the candidate cell being greater than or equal to a second threshold quality, a prediction accuracy of the prediction associated with the candidate cell being greater than or equal to a threshold accuracy, the cell switch command containing the candidate TCI state and being received within a first time duration after a reference signal for the prediction associated with the candidate cell is transmitted, or the cell switch command containing the candidate TCI state and being received within a third time duration after a report of the first apparatus regarding the prediction associated with the candidate cell is transmitted.

In some example embodiments, the first apparatus 110 may transmit, to the second apparatus 120, a report indicating at least one predicted beam associated with the candidate cell and determine that preparation for a switch to a beam of the at least one predicted beam is required during a switch to the candidate cell. For example, after performing reporting of at least one predicted beam to the second apparatus 120, the first apparatus 110 may determine that it is required to be prepared for a prediction-based beam switch with cell switching.

The preparation may include measurements associated with the at least one predicted beam. In some example embodiments, the first apparatus 110 may perform at least one measurement on at least one RS associated with the at least one predicted beam, for the preparation. In an example, the first apparatus 110 may perform at least one L1-RSRP measurement on at least one RS or QCL source RS associated with the at least one predicted beam.

In some example embodiments, after the at least one measurement, the first apparatus 110 may switch to a beam of the at least one predicted beam corresponding to the candidate TCI state, based on the candidate TCI state being known. In an example, based on the candidate TCI state being known, the first apparatus 110 may quickly adapt to changes in the transmission beam. Then, the first apparatus 110 may switch the beam corresponding to the candidate TCI state.

It is to be understood that the features and operations related to the first apparatus 110 and the second apparatus 120 as described above with reference to FIGS. 3-7 are also applicable to the process in FIG. 8 and have similar effects. For the purpose of simplification, the details thereof will not be repeated.

Several solutions of the present disclosure have been briefly described. Principle and implementations of the present disclosure will be described in detail below with reference to the accompanying drawings. It will be appreciated that acts, steps, processes, and/or flowcharts illustrated in the drawings are only examples without suggesting any limitation. For example, the steps may be performed in any suitable manner. The steps as illustrated in one or more drawings may be selectively performed in an actual implementation. Moreover, example embodiments described with reference to the drawings may be implemented separately or combined in any suitable manner. For example, one or more example embodiments shown in a single drawing may be combined with one or more example embodiments shown in one or more other drawings.

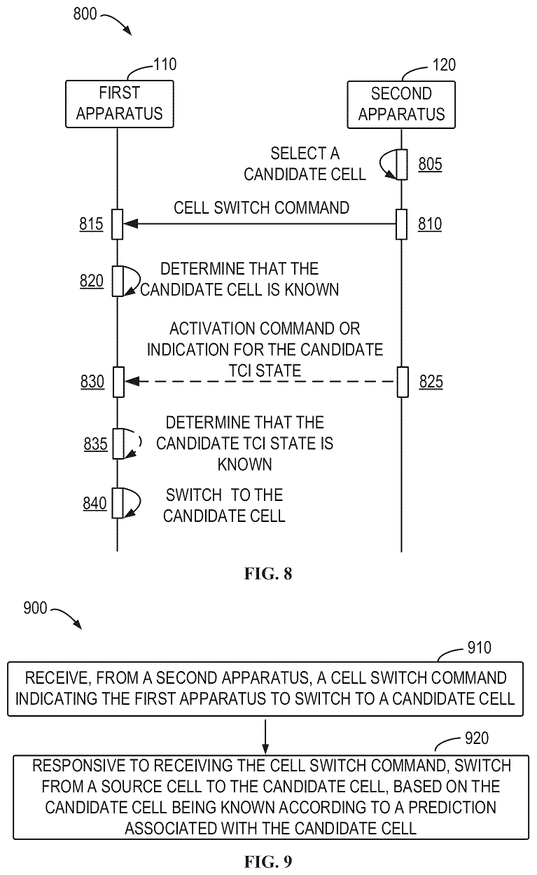

FIG. 9 shows a flowchart of an example method 900 implemented at a first apparatus in accordance with some example embodiments of the present disclosure. For the purpose of discussion, the method 900 will be described from the perspective of the first apparatus 110 in FIG. 1.

At block 910, the first apparatus 110 receives, from a second apparatus 120, a cell switch command indicating the first apparatus to switch to a candidate cell

At block 920, responsive to receiving the cell switch command, the first apparatus 110 switches from a source cell to the candidate cell, based on the candidate cell being known according to a prediction associated with the candidate cell.

In some example embodiments, the candidate cell may be known based on at least one of: a predicted reference signal associated with the candidate cell being included in a set of reference signals to be measured for the candidate cell, a report of the first apparatus containing information related to the prediction associated with the candidate cell, a first predicted signal quality of a reference signal associated with the candidate cell being greater than or equal to a first threshold quality, a second predicted signal quality corresponding to a predicted beam associated with the candidate cell being greater than or equal to a second threshold quality, or a prediction accuracy of the prediction associated with the candidate cell being greater than or equal to a threshold accuracy.

In some example embodiments, the report of the first apparatus 110 may be transmitted within a time duration before the cell switch command is received.

In some example embodiments, the predicted signal quality of the reference signal may comprise at least one of: a predicted layer 1-reference signal receiving power, or a predicted layer 3-reference signal receiving power.

In some example embodiments, the prediction associated with the candidate cell may comprise at least one of: a prediction of at least one beam associated with the candidate cell, or a prediction of a signal quality of a reference signal associated with the candidate cell.

In some example embodiments, the first apparatus 110 may apply a machine learning model to predict a first beam of the candidate cell, apply the machine learning model to obtain a first predicted signal quality related to the first predicted beam and transmit, to the second apparatus, a report containing information related to the first predicted beam and the first predicted signal quality.

In some example embodiments, the first apparatus 110 may apply the machine learning model to predict a second beam of the source cell and apply the machine learning model to obtain a second predicted signal quality related to the second predicted beam. The report further contains information related to the second predicted beam and the second predicted signal quality.

In some example embodiments, a first apparatus capable of performing any of the method 900 (for example, the first apparatus 110 in FIG. 1) may comprise means for performing the respective operations of the method 900 and any of the embodiments thereof. The means may be implemented in any suitable form. For example, the means may be implemented in a circuitry or software module. The first apparatus may be implemented as or included in the first apparatus 110 in FIG. 1.

FIG. 10 shows a flowchart of an example method 1000 implemented at a second apparatus in accordance with some example embodiments of the present disclosure. For the purpose of discussion, the method 1000 will be described from the perspective of the second apparatus 120 in FIG. 1.

At block 1010, the second apparatus 120 selects a candidate cell for a first apparatus, wherein the candidate cell is known to the first apparatus 110 according to a prediction associated with the candidate cell.

At block 1020, the second apparatus 120 transmits, to the first apparatus, a cell switch command indicating the first apparatus to switch to the candidate cell.

In some example embodiments, the candidate cell may be known based on at least one of: a predicted reference signal associated with the candidate cell being included in a set of reference signals to be measured for the candidate cell, a report of the first apparatus containing information related to the prediction associated with the candidate cell, a first predicted signal quality of a reference signal associated with the candidate cell being greater than or equal to a first threshold quality, a second predicted signal quality corresponding to a predicted beam associated with the candidate cell being greater than or equal to a second threshold quality, or a prediction accuracy of the prediction associated with the candidate cell being greater than or equal to a threshold accuracy.

In some example embodiments, the predicted signal quality of the reference signal may comprise at least one of: a predicted layer 1-reference signal receiving power, or a predicted layer 3-reference signal receiving power.

In some example embodiments, the prediction associated with the candidate cell may comprise at least one of: a prediction of at least one beam associated with the candidate cell, or a prediction of a signal quality of a reference signal associated with the candidate cell.

In some example embodiments, the second apparatus 120 may receive, from the first apparatus 110, a report containing information related to a first predicted beam of the candidate cell and a first predicted signal quality related to the first predicted beam.

In some example embodiments, the report further contains a second predicted beam of the serving cell and a second predicted signal quality related to the second predicted beam.

In some example embodiments, a second apparatus capable of performing any of the method 1000 (for example, the second apparatus 120 in FIG. 1) may comprise means for performing the respective operations of the method 1000 and any of the embodiments thereof. The means may be implemented in any suitable form. For example, the means may be implemented in a circuitry or software module. The second apparatus may be implemented as or included in the second apparatus 120 in FIG. 1.

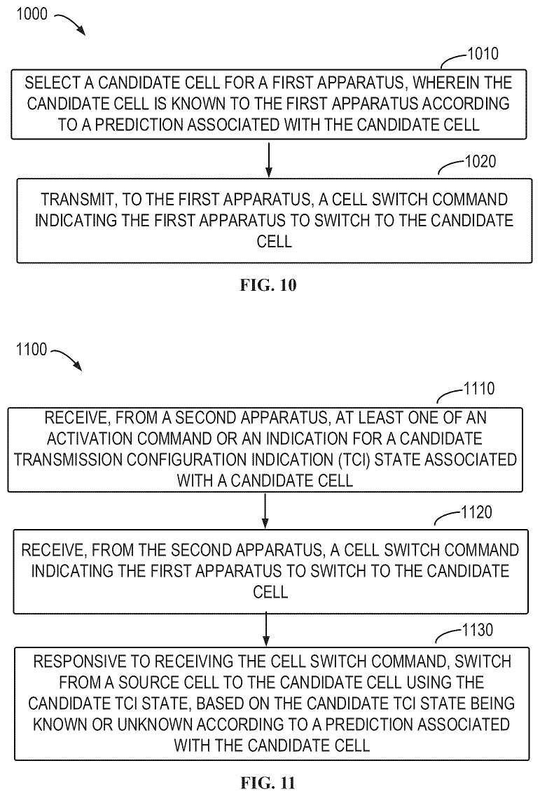

FIG. 11 shows a flowchart of an example method 1100 implemented at a first apparatus in accordance with some example embodiments of the present disclosure. For the purpose of discussion, the method 1100 will be described from the perspective of the first apparatus 110 in FIG. 1.

At block 1110, the first apparatus 110 receives, from a second apparatus 120, at least one of an activation command or an indication for a candidate transmission configuration indication (TCI) state associated with a candidate cell.

At block 1120, the first apparatus 110 receives, from the second apparatus 120, a cell switch command indicating the first apparatus to switch to the candidate cell

At block 1130, responsive to receiving the cell switch command, the first apparatus 110 switches from a source cell to the candidate cell using the candidate TCI state, based on the candidate TCI state being known or unknown according to a prediction associated with the candidate cell.

In some example embodiments, the candidate TCI state may be known based on at least one of: a predicted reference signal associated with the candidate TCI state being included in a set of reference signals to be measured for the candidate cell, a measured signal quality of a reference signal of the set of reference signals being greater than or equal to a first threshold quality, a predicted signal quality of a reference signal associated with the candidate cell being greater than or equal to a second threshold quality, a prediction accuracy of the prediction associated with the candidate cell being greater than or equal to a threshold accuracy, the cell switch command containing the candidate TCI state and being received within a first time duration after a reference signal for the prediction associated with the candidate cell is transmitted, the cell switch command containing the candidate TCI state and being received within a second time duration after a reference signal for a predicted beam of the candidate cell is transmitted, or the cell switch command containing the candidate TCI state and being received within a third time duration after a report of the first apparatus regarding the prediction associated with the candidate cell is transmitted.

In some example embodiments, the measured signal quality of the reference signal may comprise at least one of: a layer 1-reference signal receiving power, a layer 3-reference signal receiving power, or a signal to interference plus noise ratio.

In some example embodiments, the predicted signal quality of the reference signal may comprise at least one of: a predicted layer 1-reference signal receiving power, or a predicted layer 3-reference signal receiving power.

In some example embodiments, the first time duration or the second time duration is less than a prediction duration for the candidate cell, and/or larger than a measurement and reporting duration for the candidate cell.

In some example embodiments, the prediction associated with the candidate cell may comprise at least one of: a prediction of at least one beam associated with the candidate cell, or a prediction of a signal quality of a reference signal associated with the candidate cell.

In some example embodiments, the first apparatus 110 may apply the candidate TCI state based on a switching time according to a switching delay, where the switching delay is based on the candidate TCI state being known or unknown.

In some example embodiments, the first apparatus 110 may apply a machine learning model to predict a first beam of the candidate cell, apply the machine learning model to obtain a first predicted signal quality related to the first predicted beam and transmit, to the second apparatus, a report containing information related to the first predicted beam and the first predicted signal quality.

In some example embodiments, the first apparatus 110 may apply the machine learning model to predict a second beam of the source cell and apply the machine learning model to obtain a second predicted signal quality related to the second predicted beam. The report further contains information related to the second predicted beam and the second predicted signal quality.

In some example embodiments, a first apparatus capable of performing any of the method 1100 (for example, the first apparatus 110 in FIG. 1) may comprise means for performing the respective operations of the method 1100 and any of the embodiments thereof. The means may be implemented in any suitable form. For example, the means may be implemented in a circuitry or software module. The first apparatus may be implemented as or included in the first apparatus 110 in FIG. 1.

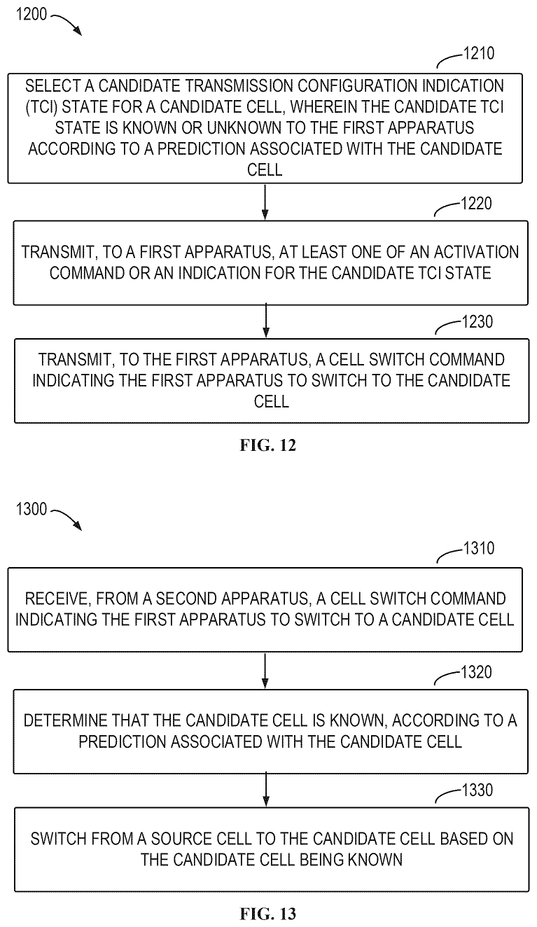

FIG. 12 shows a flowchart of an example method 1200 implemented at a second apparatus in accordance with some example embodiments of the present disclosure. For the purpose of discussion, the method 1200 will be described from the perspective of the second apparatus 120 in FIG. 1.

At block 1210, the second apparatus 120 selects a candidate transmission configuration indication (TCI) state for a candidate cell, wherein the candidate TCI state is known or unknown to the first apparatus according to a prediction associated with the candidate cell.

At block 1220, the second apparatus 120 transmits, to a first apparatus, at least one of an activation command or an indication for the candidate TCI state

At block 1230, the second apparatus 120 transmits, to the first apparatus, a cell switch command indicating the first apparatus to switch to the candidate cell.

In some example embodiments, the candidate TCI state may be known based on at least one of: a predicted reference signal associated with the candidate TCI state being included in a set of reference signals to be measured for the candidate cell, a measured signal quality of a reference signal of the set of reference signals being greater than or equal to a first threshold quality, a predicted signal quality of a reference signal associated with the candidate cell being greater than or equal to a second threshold quality, a prediction accuracy of the prediction associated with the candidate cell being greater than or equal to a threshold accuracy, the cell switch command containing the candidate TCI state and being received within a first time duration after a reference signal for the prediction associated with the candidate cell is transmitted, the cell switch command containing the candidate TCI state and being received within a second time duration after a reference signal for a predicted beam of the candidate cell is transmitted, or the cell switch command containing the candidate TCI state and being received within a third time duration after a report of the first apparatus regarding the prediction associated with the candidate cell is transmitted.

In some example embodiments, the measured signal quality of the reference signal may comprise at least one of: a layer 1-reference signal receiving power, a layer 3-reference signal receiving power, or a signal to interference plus noise ratio.

In some example embodiments, the predicted signal quality of the reference signal may comprise at least one of: a predicted layer 1-reference signal receiving power, or a predicted layer 3-reference signal receiving power.

In some example embodiments, the prediction associated with the candidate cell may comprise at least one of: a prediction of at least one beam associated with the candidate cell, or a prediction of a signal quality of a reference signal associated with the candidate cell.

In some example embodiments, the second apparatus 120 may receive, from the first apparatus 110, a report containing information related to a first predicted beam of the candidate cell and a first predicted signal quality related to the first predicted beam.

In some example embodiments, the report further contains a second predicted beam of the serving cell and a second predicted signal quality related to the second predicted beam.

In some example embodiments, a second apparatus capable of performing any

of the method 1200 (for example, the second apparatus 120 in FIG. 1) may comprise means for performing the respective operations of the method 1200 and any of the embodiments thereof. The means may be implemented in any suitable form. For example, the means may be implemented in a circuitry or software module. The second apparatus may be implemented as or included in the second apparatus 120 in FIG. 1.

FIG. 13 shows a flowchart of an example method 1100 implemented at a first apparatus in accordance with some example embodiments of the present disclosure. For the purpose of discussion, the method 1300 will be described from the perspective of the first apparatus 110 in FIG. 1.

At block 1310, the first apparatus 110 receives, from a second apparatus 120, a cell switch command indicating the first apparatus to switch to a candidate cell.

At block 1320, the first apparatus 110 determines that the candidate cell is known, according to a prediction associated with the candidate cell.

At block 1330, the first apparatus 110 switches from a source cell to the candidate cell based on the candidate cell being known.

In some example embodiments, the first apparatus 110 may transmit, to the second apparatus, a report containing information related to the prediction associated with the candidate cell. Determining that the candidate cell is known is based on the report being transmitted within a time duration before the cell switch command is received.

In some example embodiments, the first apparatus 110 may apply a machine learning model to predict a beam of the candidate cell and apply the machine learning model to obtain a predicted signal quality related to the predicted beam. Determining that the candidate cell is known is based on the predicted signal quality being greater than or equal to a threshold quality

In some example embodiments, the predicted signal quality of the reference signal may comprise at least one of: a predicted layer 1-reference signal receiving power, or a predicted layer 3-reference signal receiving power.

In some example embodiments, the first apparatus 110 may determine a prediction accuracy of the prediction associated with the candidate cell. Determining that the candidate cell is known is based on the prediction accuracy being greater than or equal to a threshold accuracy.

In some example embodiments, the first apparatus 110 may receive, from the second apparatus, at least one of an activation command or an indication for a candidate transmission configuration indication (TCI) state associated with the candidate cell and determine whether the candidate TCI state is known or unknown, according to the prediction associated with the candidate cell. Switching from the source cell to the candidate cell using the candidate TCI state is based on the candidate cell TCI state being known or unknown.

In some example embodiments, determining that the candidate TCI state is known is based on at least one of: the cell switch command containing the candidate TCI state and being received within a first time duration after a reference signal for the predication associated with the candidate cell is transmitted, or the cell switch command containing the candidate TCI state and being received within a second time duration after a reference signal for a predicted beam of the candidate cell is transmitted.

In some example embodiments, the first time duration or the second time duration is less than a prediction duration for the candidate cell, and/or larger than a measurement and reporting duration for the candidate cell.

In some example embodiments, the first apparatus 110 may apply the candidate TCI state based on a switching time according to a switching delay, where the switching delay is based on the candidate TCI state being known or unknown.

In some example embodiments, the first apparatus 110 may transmit, to the second apparatus, a report indicating at least one predicted beam associated with the candidate cell and determine that preparation for a switch to a beam of the at least one predicted beam is required during a switch to the candidate cell.

In some example embodiments, the first apparatus 110 may perform at least one measurement on at least one reference signal associated with the at least one predicted beam, for the preparation.

In some example embodiments, after the at least one measurement, the first apparatus 110 may switch to a beam of the at least one predicted beam corresponding to the candidate TCI state, based on the candidate TCI state being known.

In some example embodiments, a first apparatus capable of performing any of the method 1300 (for example, the first apparatus 110 in FIG. 1) may comprise means for performing the respective operations of the method 1100 and any of the embodiments thereof. The means may be implemented in any suitable form. For example, the means may be implemented in a circuitry or software module. The first apparatus may be implemented as or included in the first apparatus 110 in FIG. 1.

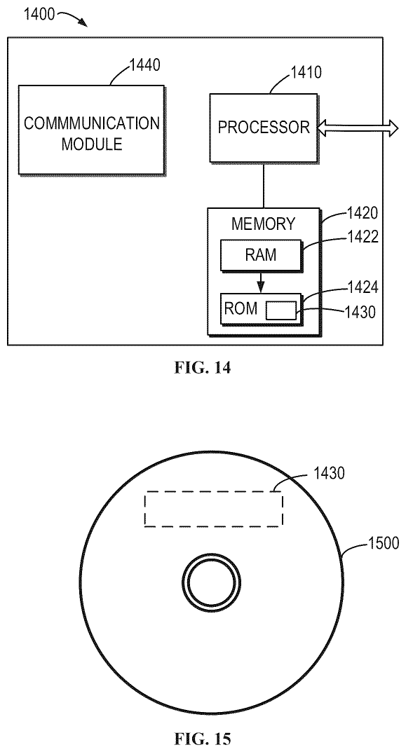

FIG. 14 is a simplified block diagram of a device 1400 that is suitable for implementing example embodiments of the present disclosure. The device 1400 may be provided to implement a communication device, for example, the first apparatus 110 and the second apparatus 120 as shown in FIG. 1. As shown, the device 1400 includes one or more processors 1410, one or more memories 1420 coupled to the processor 1410, and one or more communication modules 1440 coupled to the processor 1410.

The communication module 1440 is for bidirectional communications. The communication module 1440 has one or more communication interfaces to facilitate communication with one or more other modules or devices. The communication interfaces may represent any interface that is necessary for communication with other network elements. In some example embodiments, the communication module 1440 may include at least one antenna.

The processor 1410 may be of any type suitable to the local technical network and may include one or more of the following: general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

The memory 1420 may include one or more non-volatile memories and one or more volatile memories. Examples of the non-volatile memories include, but are not limited to, a Read Only Memory (ROM) 1424, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random-access memory (RAM) 1422 and other volatile memories that will not last in the power-down duration.

A computer program 1430 includes computer executable instructions that are executed by the associated processor 1410. The instructions of the program 1430 may include instructions for performing operations/acts of some example embodiments of the present disclosure. The program 1430 may be stored in the memory, e.g., the ROM 1424. The processor 1410 may perform any suitable actions and processing by loading the program 1430 into the RAM 1422.

The example embodiments of the present disclosure may be implemented by means of the program 1430 so that the device 1400 may perform any process of the disclosure as discussed with reference to FIG. 1 to FIG. 13. The example embodiments of the present disclosure may also be implemented by hardware or by a combination of software and hardware.

In some example embodiments, the program 1430 may be tangibly contained in a computer readable medium which may be included in the device 1400 (such as in the memory 1420) or other storage devices that are accessible by the device 600. The device 1400 may load the program 1430 from the computer readable medium to the RAM 1422 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

FIG. 15 shows an example of the computer readable medium 1500 which may be in form of CD, DVD or other optical storage disk. The computer readable medium 1500 has the program 1430 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general-purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
receive, from a second apparatus, a cell switch command indicating the first apparatus to switch to a candidate cell;
determine that the candidate cell is known, according to a prediction associated with the candidate cell; and
switch from a source cell to the candidate cell based on the candidate cell being known.

2. The first apparatus of claim 1, wherein the first apparatus is further caused to:
transmit, to the second apparatus, a report containing information related to the prediction associated with the candidate cell,
wherein determining that the candidate cell is known is based on the report being transmitted within a time duration before the cell switch command is received.

3. The first apparatus of claim 1, wherein the first apparatus is further caused to:
apply a machine learning model to predict a beam of the candidate cell; and
apply the machine learning model to obtain a predicted signal quality related to the predicted beam,
wherein determining that the candidate cell is known is based on the predicted signal quality being greater than or equal to a threshold quality.

4. The first apparatus of claim 3, wherein the predicted signal quality of the reference signal comprises at least one of:
a predicted layer 1-reference signal receiving power, or
a predicted layer 3-reference signal receiving power.

5. The first apparatus of claim 1, wherein the first apparatus is further caused to:
determine a prediction accuracy of the prediction associated with the candidate cell,
wherein determining that the candidate cell is known is based on the prediction accuracy being greater than or equal to a threshold accuracy.

6. The first apparatus of claim 1, wherein the first apparatus is further caused to:
receive, from the second apparatus, at least one of an activation command or an indication for a candidate transmission configuration indication (TCI) state associated with the candidate cell; and
determine whether the candidate TCI state is known or unknown, according to the prediction associated with the candidate cell,
wherein switching from the source cell to the candidate cell using the candidate TCI state is based on the candidate TCI state being known or unknown.

7. The first apparatus of claim 6, wherein determining that the candidate TCI state is known is based on at least one of:
the cell switch command containing the candidate TCI state and being received within a first time duration after a reference signal for the predication associated with the candidate cell is transmitted, or
the cell switch command containing the candidate TCI state and being received within a second time duration after a reference signal for a predicted beam of the candidate cell is transmitted.

8. The first apparatus of claim 7, wherein the first time duration or the second time duration is less than a prediction duration for the candidate cell, and/or larger than a measurement and reporting duration for the candidate cell.

9. The first apparatus of claim 6, wherein the first apparatus caused to switch from the source cell to the candidate cell using the candidate TCI state is caused to:
apply the candidate TCI state based on a switching time according to a switching delay, wherein the switching delay is based on the candidate TCI state being known or unknown.

10. The first apparatus of claim 6, wherein the first apparatus is further caused to:
transmit, to the second apparatus, a report indicating at least one predicted beam associated with the candidate cell; and
determine that preparation for a switch to a beam of the at least one predicted beam is required during a switch to the candidate cell.

11. The first apparatus of claim 10, wherein the first apparatus is further caused to:
perform at least one measurement on at least one reference signal associated with the at least one predicted beam, for the preparation.

12. The first apparatus of claim 11, wherein the first apparatus caused to switch from the source cell to the candidate cell using the candidate TCI state is caused to:
after the at least one measurement, switch to a beam of the at least one predicted beam corresponding to the candidate TCI state, based on the candidate TCI state being known.

13. A method comprising:
at a first apparatus,
receiving, from a second apparatus, a cell switch command indicating the first apparatus to switch to a candidate cell;
determining that the candidate cell is known, according to a prediction associated with the candidate cell; and
switching from a source cell to the candidate cell based on the candidate cell being known.

14. The method of claim 13, further comprising:
transmitting, to the second apparatus, a report containing information related to the prediction associated with the candidate cell,
wherein determining that the candidate cell is known is based on the report being transmitted within a time duration before the cell switch command is received.

15. The method of claim 13, further comprising:
applying a machine learning model to predict a beam of the candidate cell; and
apply the machine learning model to obtain a predicted signal quality related to the predicted beam,
wherein determining that the candidate cell is known is based on the predicted signal quality being greater than or equal to a threshold quality.

16. The method of claim 15, wherein the predicted signal quality of the reference signal comprises at least one of:
a predicted layer 1-reference signal receiving power, or
a predicted layer 3-reference signal receiving power.

17. The method of claim 13, further comprising:
determining a prediction accuracy of the prediction associated with the candidate cell,
wherein determining that the candidate cell is known is based on the prediction accuracy being greater than or equal to a threshold accuracy.

18. The method of claim 13, further comprising:
receiving, from the second apparatus, at least one of an activation command or an indication for a candidate transmission configuration indication (TCI) state associated with the candidate cell; and
determining whether the candidate TCI state is known or unknown, according to the prediction associated with the candidate cell,
wherein switching from the source cell to the candidate cell using the candidate TCI state is based on the candidate cell being known or unknown.

19. The method of claim 18, wherein determining that the candidate TCI state is known is based on the cell switch command containing the candidate TCI state and being received within a first time duration after a reference signal for the predication associated with the candidate cell is transmitted.

20. The first apparatus of claim 1, wherein the first apparatus is a user equipment, UE, or wherein the first apparatus is comprised in the UE.
